(19) United States
(12) Patent Application Publication
(10) Pub. No.: US 2003/0157371 A1
(43) Pub. Date: Aug. 21, 2003

(54) Nanoparticle for magnetic recording medium, magnetic recording medium using the same, and process for manufacturing magnetic recording medium

(75) Inventors: Nobutaka Ihara, Kawasaki (JP); Hiroyoshi Kodama, Kawasaki (JP); Takuya Uzumaki, Kawasaki (JP)

Correspondence Address: ARMSTRONG,WESTERMAN & HATTORI, LLP, 1725 K STREET, NW, SUITE 1000, WASHINGTON, DC, 20006, US

(73) Assignee: FUJITSU LIMITED, Kawasaki (JP)

(21) Appl. No.: 10/368,614

(22) Filed: Feb. 20, 2003

(30) Foreign Application Priority Data
Feb. 20, 2002 (JP) 2002-043879

(51) Int. Cl. G11B 5/66

(52) U.S. Cl. 428/694 BA; 428/694 BM; 428/694 R

(57) ABSTRACT

The present invention aims to provide a magnetic recording medium improved in recording density, with maintaining various performances thereof, an efficient process for manufacturing the magnetic recording medium, and a nanoparticle for a magnetic recording medium sufficiently utilized therefor. The nanoparticle for a magnetic recording medium of the present invention has an organic compound capable of generating carbon adhering to the surface thereof, or 7 nm or less of a number average particle diameter thereof, or 0.1 or less of a particle distribution (distribution width (σ)/particle diameter (D)) thereof. The magnetic recording medium of the present invention has a recording layer containing the nanoparticle for a magnetic recording medium. The process for manufacturing a magnetic recording medium of the present invention includes a step of applying, onto a substrate and in a magnetic field, a nanoparticle dispersed liquid in which the nanoparticle for a magnetic recording medium is dispersed.

### CROSS-REFERENCE TO RELATED APPLICATIONS

This application is based upon and claims the benefits of the priority from the prior Japanese Patent Application No. 2002-043879, filed in Feb. 20, 2002, the entire contents of which are incorporated herein by reference.

### BACKGROUND OF THE INVENTION

1. Field of the Invention

The present invention relates to a magnetic recording medium having a high recording density, an efficient process for manufacturing the magnetic recording medium, and a nanoparticle for a magnetic recording medium which are suitable therefor.

2. Description of the Related Art

In recent years, there have been rapid developments in making magnetic recording media have greater capacities, due to improvements made to the recording densities thereof. Generally, in order to improve the recording density of a magnetic recording medium, noise at the magnetic recording medium must be reduced. To this end, it has been required to attain the minute and uniform crystal particle diameter of magnetic bodies contained in the recording layer of the magnetic recording. In the conventional art, in order to improve the recording density of a magnetic recording medium, Japanese Patent Application Laid-Open (JP-A) No. 61-63927 for example discloses manufacturing a vertically magnetized magnetic disk as follows. While eccentrically applying a magnetic coating material, which enables formation of a vertically magnetized film, onto the surface of a disc, a vertical magnetic field and a horizontal magnetic field are applied in combination. Thereafter, by applying only a vertical magnetic field, the vertically magnetized magnetic disk is manufactured.

However, in recent years, accompanying the rapid growth of techniques in the IT industry in particular, there has been the need to provide a magnetic recording medium having a higher recording density than conventional magnetic recording media.

### SUMMARY OF THE INVENTION

An object of the present invention is to provide a magnetic recording medium having an improved recording density as compared with conventional magnetic recording media, while the various types of performances thereof are maintained. Another object of the present invention is to provide an efficient process for manufacturing the magnetic recording medium, as well as a nanoparticle for a magnetic recording medium which is suitable therefor.

A nanoparticle for a magnetic recording medium of a first aspect of the present invention is used in a magnetic recording medium, and an organic compound capable of generating carbon, adheres to the surface thereof. Since an organic compound capable of generating carbon adheres to the surface of the nanoparticle for a magnetic recording medium, when the nanoparticle is used in forming a recording layer in a magnetic recording medium, the nanoparticle easily self-align due to the intermolecular force with the other nanoparticles for a magnetic recording medium (attraction between particles, i.e., the sum of the magnetic dipole interaction and the van der Waals force), and can be aligned regularly and stably.

A nanoparticle for a magnetic recording medium of a second aspect of the present invention is used in a magnetic recording medium, and the number average particle diameter thereof is about 7 nm or less. Since the number average particle diameter of the nanoparticle for a magnetic recording medium is about 7 nm or less, when the nanoparticle is used in forming a recording layer in a magnetic recording medium, it can be aligned stably and regularly with other nanoparticles, and noise of the recording layer can be efficiently reduced.

A nanoparticle for a magnetic recording medium of a third aspect of the present invention are used in a magnetic recording medium, and the particle distribution (distribution width (σ)/particle diameter (D)) thereof is about 0.1 or less. Since the particle distribution (distribution width (σ)/particle diameter (D)) of the nanoparticle for a magnetic recording medium is about 0.1 or less, when the nanoparticle is used in forming a recording layer in a magnetic recording medium, it can be aligned stably and regularly with other nanoparticles, and noise of the recording layer can be efficiently reduced.

The magnetic recording medium of the present invention comprises a recording layer which contains the nanoparticle for a magnetic recording medium of the present invention. As the magnetic recording medium has a recording layer containing the nanoparticle for a magnetic recording medium, noise of the recording layer can be efficiently reduced.

The process for manufacturing a magnetic recording medium of the present invention comprises a step of applying, on a substrate and in a magnetic field, a nanoparticle dispersed liquid in which the nanoparticle for a magnetic recording medium of the present invention is dispersed. In the process for manufacturing a magnetic recording medium, in the step of applying, the nanoparticle for a magnetic recording medium which is in the nanoparticle dispersed liquid is applied onto the substrate in a state of being in-plane oriented. Therefore, a magnetic recording medium which has low noise and high recording density can be manufactured efficiently.

### BRIEF DESCRIPTION OF THE DRAWINGS

FIG. 1 is a schematic diagram for explanation, which shows one example of a state in which a nanoparticle dispersed liquid is being applied onto a disc-shaped substrate for a magnetic disk by a spin coating method, while a magnetic field in a vertical direction with respect to the substrate is applied.

FIG. 2 is a schematic diagram for explanation, which shows one example of a state in which the nanoparticle dispersed liquid is being applied onto the substrate by a spin coating method, while a magnetic field in a horizontal direction with respect to the substrate is applied.

FIG. 3 is a schematic diagram for explanation, which shows one example of a state in which the nanoparticle dispersed liquid is being applied onto the substrate by a spin coating method, while a magnetic field in a horizontal direction with respect to the substrate is applied.

FIG. 4 is one example of schematic diagram explaining the process for applying the nanoparticle dispersed liquid onto the substrate by a dipping method, while a magnetic field in a vertical direction is applied to the substrate.

FIG. 5 is one example of schematic sectional view of a recording layer in a magnetic recording medium obtained through a second step.

FIG. 6 is one example of schematic diagram explaining annealing processing while applying a magnetic field in a vertical direction to the substrate, in the second step.

FIG. 7 is one example of schematic diagram explaining annealing processing while applying a magnetic field in a horizontal direction to the substrate, in the second step.

FIG. 8 is one example of schematic diagram explaining annealing processing while applying a magnetic field in a horizontal direction to the substrate, in the second step.

FIG. 9 is one example of diagram explaining manufacturing the magnetic recording medium of the present invention.

### DESCRIPTION OF THE PREFERRED EMBODIMENTS

(Magnetic Recording Medium)

The magnetic recording medium of the present invention has a recording layer, and, if needed, a substrate and other layers which are appropriately selected.

-Recording Layer-

The recording layer contains a nanoparticle for a magnetic recording medium of the present invention which will be described hereinafter, and also contains other components as needed.

-Nanoparticle for Magnetic Recording Medium-

The following three aspects are examples of the nanoparticle for a magnetic recording medium.

In the nanoparticle for a magnetic recording medium of the first aspect, an organic compound capable of generating carbon adheres to the surface of the nanoparticle for a magnetic recording medium.

In the nanoparticle for a magnetic recording medium of the second aspect, the number average particle diameter of the nanoparticle for a magnetic recording medium of the second aspect is about 7 nm or less.

In the nanoparticle for a magnetic recording medium of the third aspect, the particle distribution (distribution width (σ)/particle diameter (D)) of the nanoparticle for a magnetic recording medium of the third aspect is about 0.1 or less.

In the nanoparticle for a magnetic recording medium of the first aspect, the organic compound capable of generating carbon is not particularly limited as long as it can generate carbon, and can be appropriately selected in accordance with the object. Examples are, in addition to carbon itself, oleic acid, oleylamine, hexanoic acid, hexylamine, and the like.

A single type of these compounds may be used, or two or more types may be used in combination. Thereamong, compounds which can generate carbon during the annealing processing are preferable.

In the case of the nanoparticle for a magnetic recording medium of the second aspect, the number average particle diameter of the nanoparticle must be about 7 nm or less, and is preferably 6.5 nm or less, and is more preferably 6 nm or less. In cases of the nanoparticle for a magnetic recording medium of the first and third aspects, the number average particle diameter is preferably 7 nm or less, more preferably 6.5 nm or less, and particularly preferably 6 nm or less.

If the number average particle diameter of the nanoparticle for a magnetic recording medium in more than about 7 nm, the recording density of a magnetic recording medium using the nanoparticle for a magnetic recording medium may not be sufficient.

In the case of the nanoparticle for a magnetic recording medium of the third aspect, the particle distribution (distribution width (σ)/particle diameter (D)) of the nanoparticle for a magnetic recording medium must be about 0.1 or less, and is preferably 0.09 or less, and is more preferably 0.08 or less. In cases of the nanoparticle for a magnetic recording medium of the first and second aspects, the particle distribution is preferably 0.1 or less, more preferably 0.09 or less, and particularly preferably 0.08 or less.

If the particle distribution (distribution width (σ)/particle diameter (D)) of the nanoparticle for a magnetic recording medium is more than about 0.1, the uniformity of the nanoparticle for a magnetic recording medium may deteriorate, and the recording density of a magnetic recording medium using the nanoparticle for a magnetic recording medium may be insufficient.

The nanoparticle for a magnetic recording medium is magnetic bodies and have magnetic force. The nanoparticle for a magnetic recording medium is not particularly limited, and may contain one type of element alone or may contain two or more types of elements, and may be appropriately selected from any compositions known in the art. However, it is preferable that the nanoparticle contains at least one type of element selected from d-block elements and f-block elements (transition elements).

Suitable examples of d-block elements are Co, Fe, Ni, Mn, Pt, Pd and the like.

Suitable examples of f-block elements are Sm, Nd, Pr and the like.

When the nanoparticle for a magnetic recording medium contains two or more types of elements, the nanoparticle for a magnetic recording medium are an alloy. The alloy may be any of a binary alloy, a ternary alloy, a quaternary alloy, and the like. Moreover, the alloy may contain at least one type of element selected from d-block elements and f-block elements (transitional elements), or may contain these elements and other metal elements, non-metal elements (B, N and the like), semimetal elements, and the like. Further, the organizational state of the alloy may be an intermetallic compound, or may be a mixture.

Although the process for manufacturing the nanoparticle for a magnetic recording medium is not particularly limited and may be appropriately selected from any processes known in the art, preferable examples include a polyol method, a heat plasma method, and the like. Thereamong, the polyol method is particularly suitable.

The polyol method is advantageous in that the organic compound capable of generating carbon can be efficiently adhered to the surface of the nanoparticle for a magnetic recording medium, the nanoparticle for a magnetic recording medium can be aligned regularly and stably by self-alignment, and nanoparticle for a magnetic recording medium which have a minute and uniform particle diameter can be efficiently manufactured.

The polyol method is a chemical synthesis method disclosed by Sun et al. in Science, 287, 1989 (2000), and in JP-A No. 2000-54012, and the like.

In the polyol method, when an FePt nanoparticle is to be manufactured as the nanoparticle for a magnetic recording medium for example, after a component containing a Pt complex and a reducing agent is dissolved in a solvent, an Fe complex and stabilizers (oleic acid, oleylamine, and the like) are added thereto. By heating the mixture while refluxing and stirring, a metal precursor solution is prepared. Thereafter, the obtained metal precursor solution is heated and stirred, and FePt nanoparticles are grown.

In growing the FePt nanoparticles, control of the nanoparticle diameter and control of the particle interval are carried out by the effects of the stabilizers. More specifically, by using oleylamine as the stabilizer, the growth of the FePt nanoparticles is suppressed. By using oleic acid as the stabilizer, the surface of the FePt nanoparticles is covered, and FePt nanoparticles in which an organic compound is adhered to the surface are obtained. Thus, in the polyol method, the particle diameter of the obtained FePt nanoparticles is determined by the type of the stabilizer, and the width between the FePt nanoparticles (the particle interval) is determined by the type of the stabilizer (the alkyl chain length in the stabilizer). For example, when oleylamine and oleic acid are used as the stabilizers, the number average particle diameter of the obtained FePt nanoparticle is 6 nm, and the particle interval at Fe₅₀Pt₅₀ nanoparticle is 4 nm. Further, when hexylamine and hexanoic acid are used as the stabilizers, the number average particle diameter of the obtained FePt nanoparticle is 6 nm, and the particle interval at Fe₅₀Pt₅₀ nanoparticle is 1 nm.

An organic compound capable of generating carbon, namely, the stabilizer, adheres to the surface of the nanoparticle for a magnetic recording medium. Therefore, the nanoparticle is stable, and can be handled easily even in air. Further, the nanoparticle can be easily re-dispersed in a predetermined solvent such as hexane and the like. Thus, after re-dispersing the nanoparticle in a predetermined solvent, another predetermined solvent is added in order to precipitate the nanoparticle, and then centrifuging the precipitate and removing the supernatant, so that the synthetic by-products and unreacted reagents are removed. In this way, the nanoparticle can be refined efficiently.

The nanoparticle for a magnetic recording medium contained in the recording layer is oriented randomly in three dimensions. However, the easy magnetization axis thereof is preferably oriented either in the vertical direction or the horizontal direction, with respect to the surface of the recording layer (the surface of the magnetic recording medium having the recording layer).

When the nanoparticle for a magnetic recording medium is in-plane oriented in this way, there is the advantage that the recording density of the magnetic recording medium using the nanoparticle for a magnetic recording medium can be improved.

-Other Components-

The other components can be appropriately selected from among a range of components which do not adversely affect the effects of the present invention. Examples include any magnetic particles known in the art, and the like, which are generally contained in the recording layer of a magnetic recording medium. The other components may be used singly or in combination of two or more.

The thickness of the recording layer is not particularly limited, and may be appropriately selected in accordance with the object. However, a thickness of approximately 5 nm to 100 nm is preferable, and 5 nm to 50 nm is more preferable.

-Substrate-

The configuration, structure, size, material and the like of the substrate are not particularly limited and may be appropriately selected in accordance with the object. When the magnetic recording medium is a magnetic disk such as a hard disk and the like, for example, the configuration of the substrate is disc-shaped, and the material of the substrate is at least any one selected from aluminum, glass, silicon, quartz, SiO₂/Si forming a thermal oxidation film on a silicon surface, and the like.

-Other Layers-

The other layers are not particularly limited, and may be appropriately selected in accordance with the object. Examples are a seed layer provided between the recording layer and the substrate, a protective layer protecting the recording layer, and the like.

The seed layer is not particularly limited, and may be appropriately selected in accordance with the object. Examples are non-magnetic seed layers containing Cr, Co, and the like.

The protective layer is not particularly limited, and may be appropriately selected in accordance with the object. Examples are a layer containing DLC (diamond like carbon), and the like. The protective layer can be formed, for example, by accumulating DLC on the recording layer by a plasma CVD method, and a lubricating oil may be applied onto the surface thereof by dipping and the like.

As compared with a conventional magnetic recording medium, the above-described magnetic recording medium of the present invention has excellent recording density while the respective performances thereof are maintained. Therefore, the magnetic recording medium of the present invention can be suitably used in various types of recording fields, and is particularly preferably used as a magnetic recording medium such as a magnetic disk for the use of a hard disk and the like. In the present invention, the magnetic recording medium includes a photomagnetic recording material.

The magnetic recording medium of the present invention can be manufactured by a process which has been appropriately selected, but is preferably manufactured by the process for manufacturing a magnetic recording medium of the present invention which will be described hereinafter.

(Process for Manufacturing Magnetic Recording Medium)

The process for manufacturing the magnetic recording medium of the present invention includes at least a step of applying a nanoparticle dispersed liquid, in which the nanoparticle for a magnetic recording medium of the present invention is dispersed, onto the substrate in a magnetic field. If needed, the process for manufacturing may also include a step of annealing in a magnetic field, which is carried out either simultaneously with or after the step of applying. The process for manufacturing may also include other steps which are appropriately selected in accordance with the object.

-Step of Applying-

The step of applying is a step of applying a nanoparticle dispersed liquid, in which the nanoparticles for a magnetic recording medium of the present invention are dispersed, onto the substrate in a magnetic field.

In the process of evaporating the solvent included in the nanoparticle dispersed liquid after applying the nanoparticle dispersed liquid onto the substrate, within the step of applying, the nanoparticle for a recording medium self-organize due to the attraction between particles (the sum of the magnetic dipole interaction and the van der Waals force) since the organic compound adheres to the surface of the nanoparticle for a magnetic recording medium. As a result, a multiplayer-terrace-like superlattice structure is formed.

The nanoparticle for a magnetic recording medium is magnetic bodies and have magnetic force, and can freely move in the nanoparticle dispersed liquid. Thus, at the time of applying the nanoparticle dispersed liquid onto the substrate, when a magnetic field in the vertical direction with respect to the substrate is applied, a magnetic recording medium, whose recording density is high and in which the easy magnetization axis is oriented in a vertical direction with respect to the direction of thickness of the substrate, can be manufactured efficiently. Further, at the time of applying the nanoparticle dispersed liquid onto the substrate, when a magnetic field in the horizontal direction with respect to the substrate is applied, a magnetic recording medium, whose recording density is high and in which the easy magnetization axis is oriented in the horizontal direction (i.e., the in-plane direction) of the substrate, can be manufactured efficiently.

The method for applying the nanoparticle dispersed liquid is not particularly limited, and can be appropriately selected in accordance with the object. Examples include a spin coating method, a dipping method, and the like.

Here, the step of applying will be described with reference to the figures.

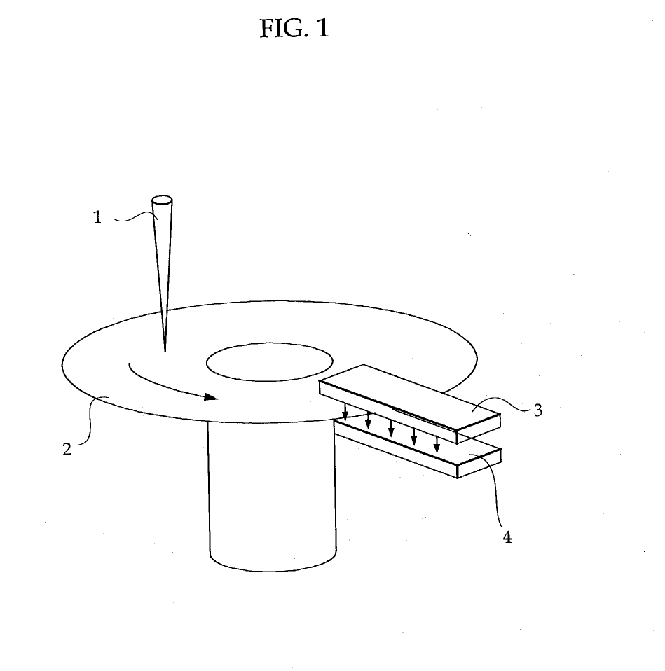

FIG. 1 is a schematic diagram for explanation, which shows one example of state in which a nanoparticle dispersed liquid is being applied onto a disc-shaped substrate for a magnetic disk, which is rotated in the direction shown with the arrow by a spin coating method, while a magnetic field in a vertical direction with respect to the substrate is applied. In the case illustrated in FIG. 1, S pole 3 and N pole 4 of magnets are used. By disposing S pole 3 and N pole 4 above and below the substrate 2, a magnetic field, which is a vertical direction with respect to the substrate and whose direction of magnetic flux is the vertical direction as shown with arrows, is applied. In this state, when the nanoparticle dispersed liquid 1 is applied in drops and spin coated on the substrate. In the recording layer which is formed on the substrate, the easy magnetization axis of the nanoparticle for a magnetic recording medium is oriented in the vertical direction with respect to the substrate.

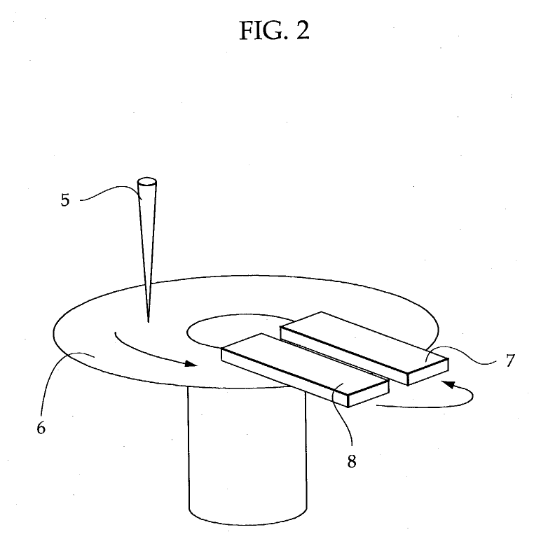

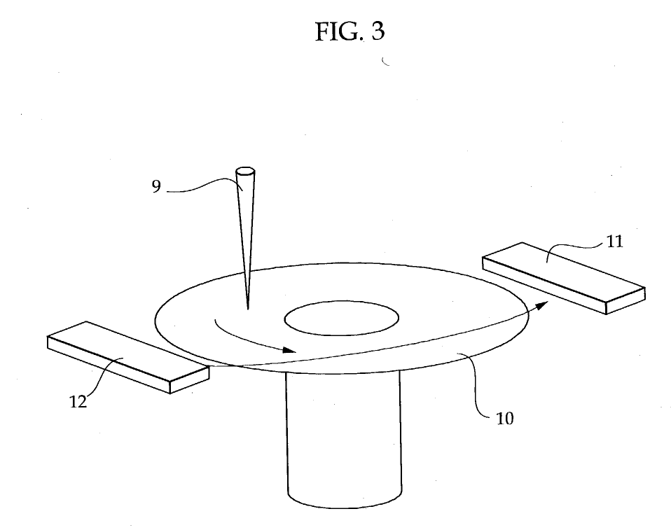

FIGS. 2 and 3 are schematic diagrams for explanation, which show examples of state in which the nanoparticle dispersed liquid, is being applied onto the substrate by a spin coating method, while a magnetic field in a horizontal direction with respect to the substrate is applied. In the case illustrated in FIG. 2, S pole 7 and N pole 8 of magnets are used. By disposing S pole 7 and N pole 8 horizontally with respect to the substrate 6 and adjacent above the substrate 6, a magnetic field, which is a horizontal direction (i.e., the in-plane direction) with respect to the substrate and whose direction of magnetic flux, as shown with the arrow, is the radial direction of the substrate 6, is applied. In this state, when the nanoparticle dispersed liquid 5 is applied in drops onto and spin coated on the substrate 6 which is rotated in the direction of the arrow. In the recording layer which is formed on the substrate, the easy magnetization axis of the nanoparticle for a magnetic recording medium is the horizontal direction (i.e., in-plane direction) with respect to the substrate 6, and is oriented in the radial direction of the substrate 6. Further, in the case shown in FIG. 3, S pole 11 and N pole 12 of magnets are used. By disposing S pole 11 and N pole 12 horizontally with respect to the substrate 10 and above the substrate 10 and so as to oppose one another across the substrate 10 with a predetermined distance therebetween, a magnetic field, which is the horizontal direction (i.e., the in-plane direction) with respect to the substrate and whose direction of magnetic flux, as shown with the arrow is a direction substantially orthogonal to the radial direction of the substrate (i.e., is the circumferential direction), is applied. In this state, when the nanoparticle dispersed liquid 9 is applied in drops onto and spin coated on the substrate which is rotated in the direction shown with the arrow. In the recording layer which is formed on the substrate 10, the easy magnetization axis of the nanoparticle for a magnetic recording medium is the horizontal direction (i.e., in-plane direction) with respect to the substrate 10, and is oriented in a direction substantially orthogonal to the radial direction of the substrate 10 (i.e., in the circumferential direction).

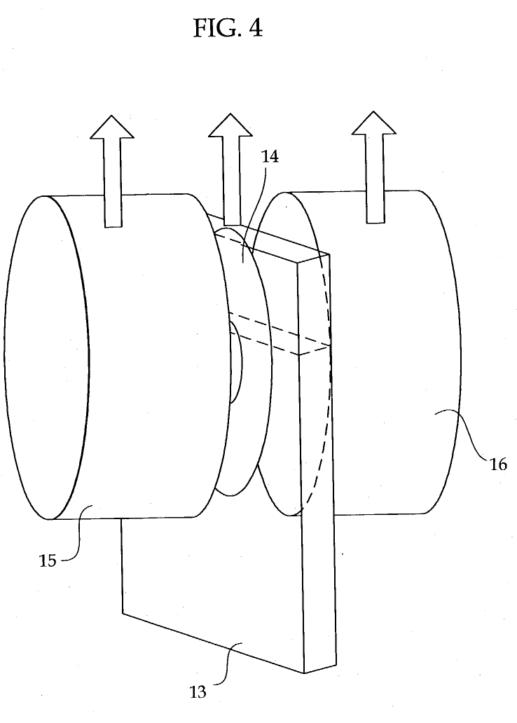

FIG. 4 is one example of schematic diagram for explanation which shows a state in which the nanoparticle dispersed liquid is being applied onto the substrate by a dipping method, while a magnetic field in a vertical direction with respect to the substrate is applied. In the case shown in FIG. 4, electromagnets 15, 16 are used. The electromagnets 15, 16 are disposed on either side of a container which houses the nanoparticle dispersed liquid 13, and are disposed so as to oppose one another such that respective portions thereof are positioned higher than the liquid surface of the nanoparticle dispersed liquid. In this way, a magnetic field, which is the direction in which the electromagnets 15, 16 oppose each other and whose direction of magnetic flux is this opposing direction, is applied. In this state, after the substrate 14 is immersed in the nanoparticle dispersed liquid such that the substrate surface is directed in a direction substantially orthogonal to the direction in which the electromagnets oppose one another, when the substrate 14 is raised up as shown with the arrows, a recording layer is formed on the substrate. In this recording layer, the easy magnetization axis of the nanoparticle is oriented in the vertical direction with respect to the substrate.

The strength of the magnetic field applied in the applying step is not particularly limited, and may be appropriately selected in accordance with the object. However, a strength of 10 kOe or more is preferable, and 15 kOe or more is more preferable.

If the strength of the magnetic field is less than 10 kOe, the orientation of the easy magnetization axis of the nanoparticle for a magnetic recording medium may be insufficient.

-Step of Annealing-

The step of annealing is a step of annealing in a magnetic field, and is carried out either simultaneously with or after the step of applying.

In the step of annealing, the nanoparticle for a magnetic recording medium, for example an alloy such as FePt, CoPt, or the like, is regulated, and the orientation of the easy magnetization axis of the nanoparticle for a magnetic recording medium is strengthened even more.

With regard to the strength of the magnetic field applied in the step of annealing, the same as that described above in the case of the step of applying holds.

The direction of the magnetic field applied in the step of annealing is preferably the same direction as the direction in the step of applying.

The annealing is preferably carried out in a mixed gas atmosphere of at least any of H₂, N₂, He, Ne, Kr, Xe, and Ar.

The method for annealing is not particularly limited, and can be appropriately selected from any annealing processing methods known in the art. For example, when the nanoparticle for a magnetic recording medium is an FePt nanoparticle, a method may be used in which, after the nanoparticle dispersed liquid is applied in a magnetic field by the step of applying, the substrate is maintained for 30 minutes at 300 to 600° C. in an N₂ atmosphere.

By carrying out annealing, it is possible to obtain a high-performance magnetic recording medium containing the nanoparticle for a magnetic recording medium whose magnetic particle diameter is minute and uniform and in which the easy magnetization axis is strongly oriented either in the vertical direction or the horizontal direction.

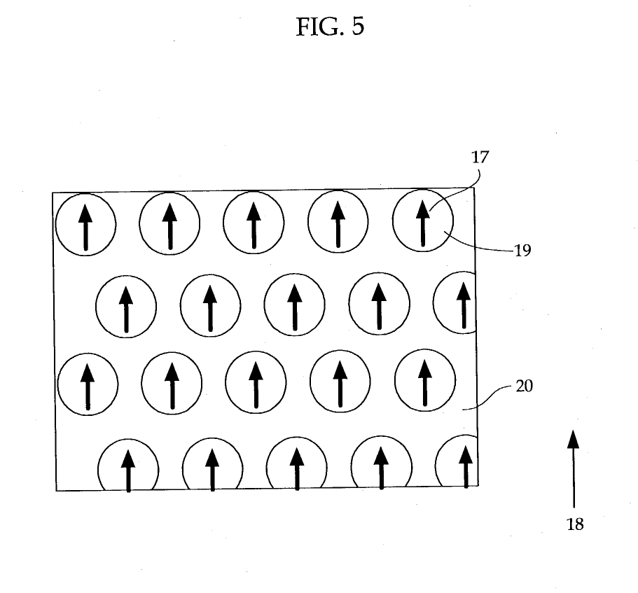

Here, the state of orientation of the nanoparticle for a magnetic recording medium in a cross-section which is horizontal with respect to the substrate surface of the recording layer of the magnetic recording medium obtained by the above-described step of annealing, will be described with reference to the figures. As shown in FIG. 5, the easy magnetization axis of the nanoparticle for a magnetic recording medium 17 is oriented in the direction of magnetization 18. A non-magnetic carbon 20, which is generated by the annealing in the step of annealing, is adhered to the surface of the nanoparticle 19. Thus, due to the non-magnetic carbon 20, the nanoparticle 19 is self-aligned regularly and at uniform particle intervals.

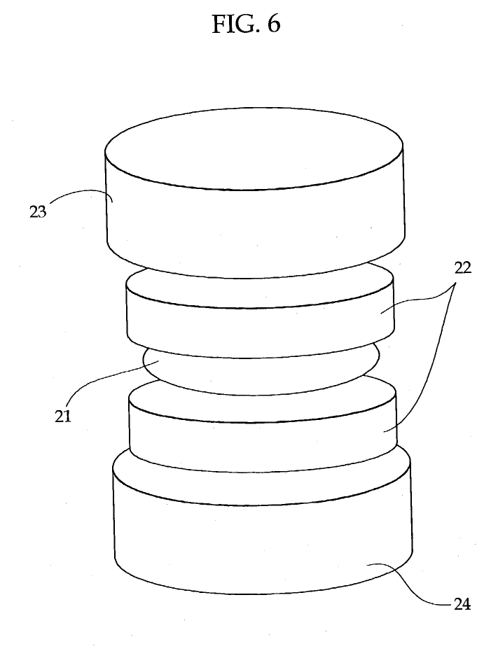

For example, the annealing can be carried out by using a heating device such as a lamp heater, a PBN heater, in vacuum, in nitrogen, in argon-nitrogen, and the like. Specifically, as shown in FIG. 6, the annealing can be carried out by disposing heaters 22 above and below the disc-shaped substrate for the magnetic disk 21. In the case of FIG. 6, in the applying step, an electromagnet 23 and a superconducting magnet 24 are used. By disposing the electromagnet 23 and the superconducting magnet 24 above and below the substrate 21, a magnetic field, which is the vertical direction with respect to the substrate and whose direction of magnetic flux is the vertical direction, is applied. In this state, when annealing is carried out, in the recording layer formed on the substrate, the nanoparticle for a magnetic recording medium self-aligns regularly and at uniform particle intervals in a state in which the easy magnetization axis thereof is oriented at a high rate of orientation in the vertical direction with respect to the substrate.

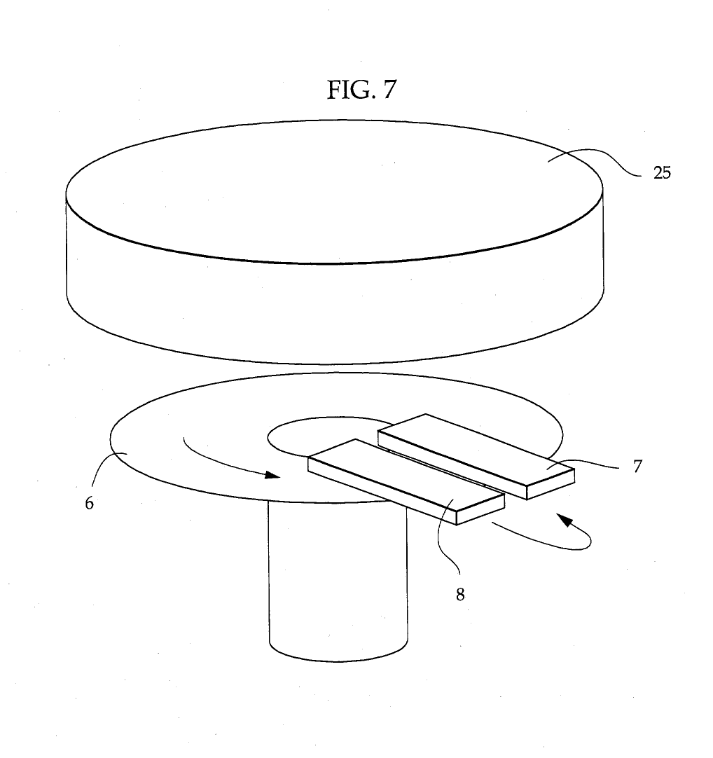

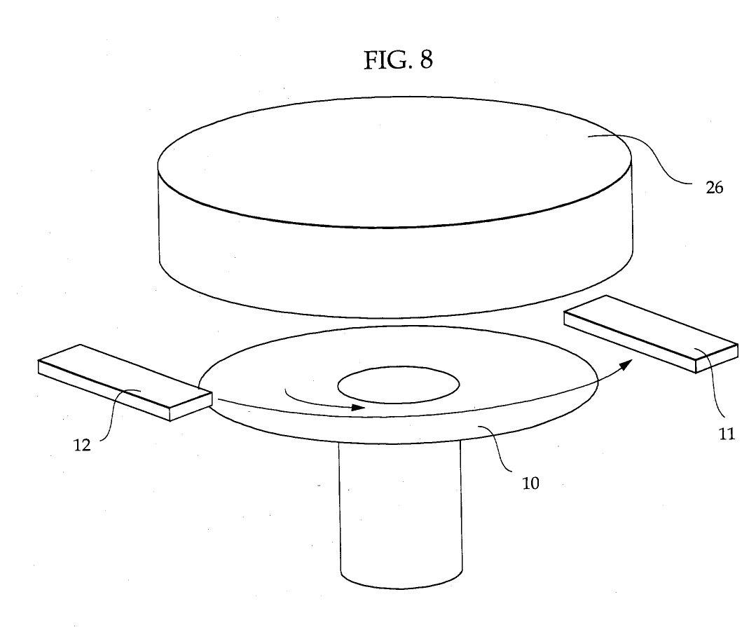

The annealing can be carried out by disposing a heating device such as a heater 25 or 26 above the substrate, as shown in FIG. 7 in the case of an applying step such as that shown in FIG. 2, or as shown in FIG. 8 in the case of an applying step such as that shown in FIG. 3. By carrying out annealing, in the recording layer formed on the substrate, the nanoparticle for a magnetic recording medium self-aligns regularly such that the easy magnetization axis thereof is oriented at a higher rate of orientation in the horizontal direction (the in-plane direction) with respect to the substrate, and is oriented at a high rate of orientation in the radial direction (in the case of FIG. 7) or the circumferential direction (in the case of FIG. 8) of the substrate.

When annealing is carried out with the condition of that the nanoparticle for a magnetic recording medium is an FePt nanoparticle for example, the random phase in the FePt nanoparticle before annealing, is a fcc structure, and <100> is the easy magnetization axis. In the step of applying, if the nanoparticle dispersed liquid is applied while a magnetic field in the vertical direction with respect to the substrate is applied, for example, the easy magnetization axis <100> can be aligned in the vertical direction with respect to the substrate. Thereafter, in the step of annealing, when annealing is carried out in a magnetic field applied in the vertical direction with respect to the substrate, the FePt nanoparticle can be made to be a regulated alloy, while the easy magnetization axis thereof is maintained oriented in the vertical direction with respect to the substrate, and the FePt nanoparticle can be made to be an fct structure.

Hereinafter, an Example of the present invention will be described. However, the present invention is not to be limited to this Example. The following Example is an Example in which the magnetic recording medium of the present invention, which uses the nanoparticle for a magnetic recording medium of the present invention, is manufactured by the process for manufacturing a magnetic recording medium of the present invention.

(1) Preparation of Metal Precursor Solution

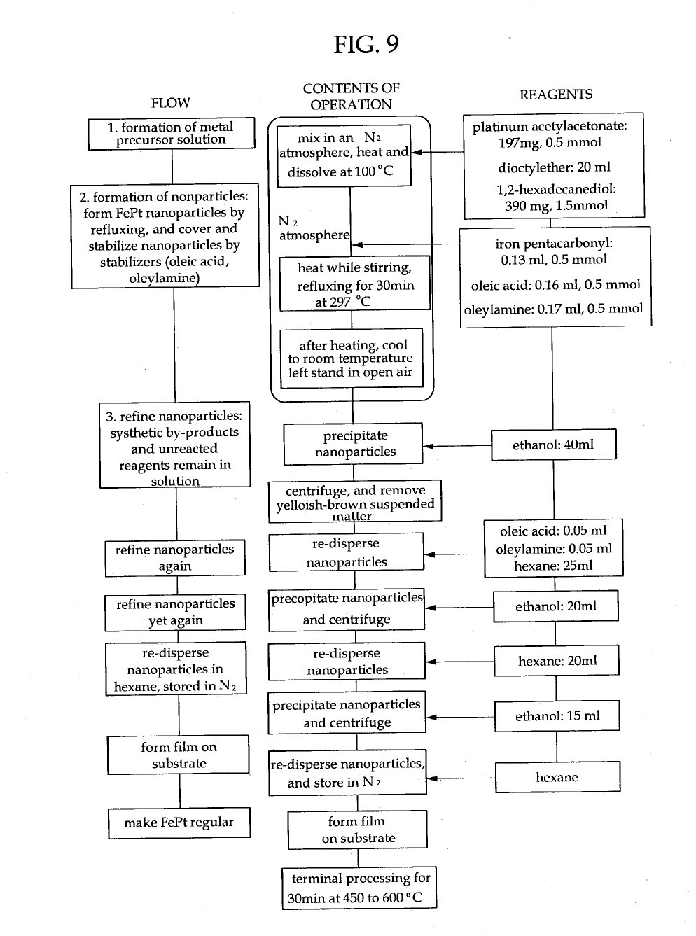

First, FePt nanoparticles as the nanoparticles for a magnetic recording medium were prepared by the polyol method. As shown in FIG. 9, Pt complex (platinum acetylacetonate Pt(C₅H₇O₂)₂: 197 mg, 0.5 mmol) and a reducing agent (1,2-hexadecanediol: 390 mg, 1.5 mmol) were dissolved in a solvent (dioctylether: 20 ml) at 100° C. in N₂ atmosphere. Thereafter, Fe complex (iron pentacarbonyl Fe(CO)₅: 0.13 ml, 1 mmol) and stabilizers (oleic acid: 0.16 ml, 0.5 mmol; and oleylamine: 0.17 ml, 0.5 mmol) were added thereto. The mixture was heated to 297° C. while being refluxed and stirred, and then a metal precursor solution was prepared.

(2) Manufacture of Nanoparticles for Magnetic Recording Medium

Next, the obtained metal precursor solution was stirred for 30 minutes at 297° C., and FePt nanoparticles were grown.

(3) Refining of Nanoparticles for Magnetic Recording Medium

Next, after the obtained FePt nanoparticles were re-dispersed in hexane, ethanol was added. The FePt nanoparticles were precipitated and then centrifuged. By removing the supernatants, the synthetic by-products and unreacted reagents were removed, and the FePt nanoparticles were refined.

(4) Step of Applying

A nanoparticle dispersed liquid, in which the above FePt nanoparticles were re-dispersed in hexane, was applied onto a disc-shaped substrate by a spin coating method in a magnetic field of 10 kOe as shown in FIG. 2. The solvent was made to evaporate and a film was formed, such that a recording layer was formed.

(5) Step of Annealing

Thermal processing of the recording layer was carried out for 30 minutes at the range of 300 to 650° C. as shown in FIG. 7 such that annealing was carried out, and the magnetic recording medium was manufactured.

In accordance with the present invention, it is possible to provide a magnetic recording medium which has improved recording density over conventional magnetic recording media, while the various performances thereof are maintained, and to provide an efficient process for manufacturing the magnetic recording medium, as well as nanoparticles for a magnetic recording medium which are suitable therefor.

What is claimed is:

1. A nanoparticle for a magnetic recording medium, comprising:
an organic compound capable of generating carbon, adhering to a surface of a nanoparticle.

2. A nanoparticle for a magnetic recording medium according to claim 1, wherein carbon adheres to the surface of the nanoparticle.

3. A nanoparticle for a magnetic recording medium according to claim 1, wherein a number average particle diameter of the nanoparticle for a magnetic recording medium is 7 nm or less.

4. A nanoparticles for a magnetic recording medium according to claim 1, wherein a particle distribution (distribution width (σ)/particle diameter (D)) of the nanoparticle for a magnetic recording medium is 0.1 or less.

5. A nanoparticles for a magnetic recording medium according to claim 1, wherein the nanoparticle for a magnetic recording medium comprise at least one type of element selected from d-block elements and f-block elements.

6. A nanoparticles for a magnetic recording medium according to claim 5, wherein the d-block elements and f-block elements are Co, Fe, Ni, Mn, Sm, Nd, Pr, Pt, and Pd.

7. A nanoparticle for a magnetic recording medium according to claim 1, wherein the nanoparticle for a magnetic recording medium are manufactured by a polyol method.

8. A nanoparticle for a magnetic recording medium, wherein a nanoparticle is in a magnetic recording medium and a number average particle diameter is 7 nm or less.

9. A nanoparticle for a magnetic recording medium, wherein a nanoparticle is used in a magnetic recording medium, and a particle distribution (distribution width (σ)/particle diameter (D)) is 0.1 or less.

10. A magnetic recording medium comprising a recording layer containing a nanoparticle for a magnetic recording medium,
wherein the nanoparticle comprise an organic compound, capable of generating carbon, adhering to a surface of a nanoparticle.

11. A magnetic recording medium according to claim 10, further comprising a substrate,
wherein an easy magnetization axis of the nanoparticle for a magnetic recording medium is oriented in one of a vertical direction and a horizontal direction with respect to the substrate.

12. A magnetic recording medium according to claim 10, wherein the nanoparticle for a magnetic recording medium have an fct structure.

13. A magnetic recording medium according to claim 10, wherein the nanoparticle for a magnetic recording medium is in-plane oriented.

14. A process for manufacturing a magnetic recording medium comprising the step of:
applying, onto a substrate and in a magnetic field, a nanoparticle dispersed liquid in which the nanoparticle for a magnetic recording medium is dispersed;
wherein the nanoparticle for a magnetic recording medium comprise an organic compound, capable of generating carbon, adhering to the surface.

15. A process for manufacturing a magnetic recording medium according to claim 14, further comprising the step of:
annealing, in a magnetic field, either simultaneously with or after the step of applying.

16. A process for manufacturing a magnetic recording medium according to claim 15, wherein the step of annealing is carried out in a mixed gas atmosphere of at least one of H₂, N₂, He, Ne, Kr, Xe and Ar.
